(19) United States
(12) Patent Application Publication
(10) Pub. No.: US 2011/0048134 A1
(43) Pub. Date: Mar. 3, 2011

(54) ULTRASONIC DIAGNOSTIC APPARATUS

(76) Inventors: Yoriyasu Ozaki, Kyoto (JP); Samuel James Mckown, Anaheim, CA (US)

(21) Appl. No.: 12/574,236

(22) Filed: Oct. 6, 2009

(30) Foreign Application Priority Data
Aug. 26, 2009 (JP) 2009-195661

(51) Int. Cl. G01N 29/04

(52) U.S. Cl. 73/627

(57) ABSTRACT

The invention provides an ultrasonic diagnostic apparatus including a signal generating part for generating a chirp wave; a compression processing part for performing a compression process on the chirp wave and outputting a chirp compression signal; and a probe for generating a SH wave based on the chirp compression signal and propagating the SH wave in the test object.

This application claims priority under 35 U.S.C. §119 to Japanese Patent Application No. 2009-195661, filed on Aug. 26, 2009, which is incorporated by reference.

### BACKGROUND OF THE INVENTION

1. Field of the Invention

The present invention relates to an ultrasonic diagnostic apparatus for detecting a defect in a test object.

2. Description of the Background Art

It is known in the art that most ultrasonic diagnostic apparatus such as the ultrasonic flaw inspection apparatus or the ultrasonic thickness inspection apparatus is structured as shown in FIG. 23. In this ultrasonic diagnostic apparatus, a synchronization signal generating part 101 emits a synchronization signal with a constant pulse cycle to a sending part 102. The sending part 102 sends a sending pulse signal Sₐ with the designated pulse width to a probe 103 by synchronizing with the synchronization signal. The probe 103 emits an ultrasonic wave synchronized with the sending pulse signal Sₐ to a test object 104, receives a reflecting ultrasonic wave (echo) from the test object 104, converts the echo into an electrical echo signal S_{b}, and sends the echo signal S_{b} to a receiving part 105. The receiving part 105 amplifies the received echo signal S_{b} and sends an amplified echo signal S_{c} to a display part 106. The display part 106 displays the amplified echo signal S_{c}.

In the ultrasonic diagnostic apparatus, the sending pulse signal Sₐ sent from the sending part 102 is a narrowband signal such as a short-pulse or a burst signal. Depending on the material of the test object 104, the pulse width and the output intensity of the sending pulse signal Sₐ require further adjustments. Frequency characteristics of the ultrasonic wave from the probe 103 are highly dependent on the transducer characteristics of the probe 103. Therefore, from a practical point of view, the adjustment work based on the characteristics of the test object 104 requires a lot of effort and time.

The ultrasonic diagnostic apparatus equipped with a wave number varying circuit and a frequency varying circuit between the synchronization signal generating part 101 and the sending part 102 is known as the apparatus to solve this problem (for example, see Japanese publication of examined patent application No. H03-43586). The ultrasonic diagnostic apparatus as set forth in Japanese publication of examined patent application No. H03-43586 is easy to adjust the frequency of ultrasonic waves since the sending frequency and the sending wave number are variable. However, in this ultrasonic diagnostic apparatus, the ultrasonic wave from the probe has a pulse width longer than the pulse transmission interval. Therefore, this ultrasonic diagnostic apparatus has the poor resolution of temporal axis.

In addition, as shown in FIG. 24, echoes which can be detected by the ultrasonic diagnostic apparatus include a echo reflected from the surface of a test object 107 (S echo 110), echoes reflected from defects 108, 109 inside the test object 107 (F echoes 111, 112) and a echo reflected from the bottom surface of the test object 107 (B echo 113), in cases that there exist the defects such as cracks and cavities inside the test object 107. The S echo 110 has the amplitude considerably larger than that of the F echoes 111, 112, which is saturated within a certain time frame. A certain depth which is equivalent to the propagation distance of the ultrasonic wave within the said time frame is referred to as the surface blind section. Within the province of the surface blind section, it is difficult to detect a defect in the test object 107. Generally, it is said that there is a 3 mm surface blind section for one-transducer inspection for a steel sheet. In case of a thinner steel sheet, S echo 110 makes the detection of a defect near the surface of the steel sheet more difficult and B echo 113 makes the detection of a defect near the bottom of the steel more difficult.

The ultrasonic wave repeatedly reflects at the bottom and surface of the test object. The reflecting ultrasonic waves (echoes) include the direct reflection wave from the defect, the indirect reflection wave that does not alter the mode 114, and the indirect reflection wave that alters the mode 115 as shown in FIG. 25. All these waves are displayed as received signals, and it is thus difficult to identify the exact number of the defect and the exact position of the defect. Moreover, the indirect reflection wave that alters the mode 115 may have the excess signal intensity. The ultrasonic wave tends to alter the mode once it contacts the bottom of the test object or the defect. The reflection ultrasonic wave altering the mode may be observed as noise.

Any obstacles on the test object such as the steel sheet may influence the propagation of the surface wave or the guiding wave, which propagate in the steel sheet and reflect by the obstacles. The obstacles may interfere with the measurement and make the measurement more difficult.

The conventional ultrasonic diagnostic apparatus has been used to check for and measure the location or the size of defects such as scars, cracks, cavities or rust near the welding location as shown in FIG. 26. In order to detect the entire test object, a huge amount of measurement points are required, thus the conventional ultrasonic diagnostic apparatus has not been used for such purposes.

Also, in most cases, the material used as the transducer of the probe is ceramic and the material used as the wedge material is acryl. The ceramic is very general, but has a low sensitivity. The acryl is heavily-damped if used at the high frequency. The probe is not appropriate for detecting the entire test object.

### SUMMARY OF THE INVENTION

The present invention has been made in view of the above circumstances, and an objective thereof is to provide an ultrasonic diagnostic apparatus which permits higher accuracy of the inspection of the location or the number of defects with the noise reduced signal and which permits the wide-ranging inspection of the defect.

To solve the above problem, the present invention provides an ultrasonic diagnostic apparatus for detecting a defect in a test object comprising: a signal generating part for generating a chirp wave; a compression processing part for performing a compression process on the chirp wave and outputting a chirp compression signal; and a probe for generating a SH wave based on the chirp compression signal and propagating the SH wave in the test object.

Moreover, the present invention also provides the probe such that the probe receives the SH wave reflected by the defect in the test object and converts the SH wave to an electric signal.

Moreover, the present invention also provides the ultrasonic diagnostic apparatus to further comprise a receiving probe which receives the SH wave reflected by the defect in the test object and converts the SH wave to an electric signal.

Preferably, the ultrasonic diagnostic apparatus further comprises a noise processing part for performing the noise processing on the electric signal, a cross correlation processing part for generating a electric compression signal by taking the cross correlation between the electric signal after the noise processing and a reference wave, and a display part for displaying the electric compression signal.

Preferably, the noise processing part comprises an averaging circuit for averaging the electric signal.

Preferably, the probe comprises a transducer composed of a composite material and a wedge composed of polyethylene.

In addition, the present invention provides an ultrasonic diagnostic apparatus for detecting a defect in a test object comprising: a signal generating part for generating a chirp wave; a compression processing part for performing a compression process on the chirp wave and outputting a chirp compression signal; and a two-transducer probe for generating a SH wave and a SV wave based on the chirp compression signal and alternately propagating the SH wave and the SV wave in the test object.

Moreover, the present invention also provides the two-transducer probe such that the two-transducer probe receives the SH wave and the SV wave reflected by the defect in the test object and respectively converts to a first electric signal based on the SH wave and a second electric signal based on the SV wave.

Moreover, the present invention also provides the ultrasonic diagnostic apparatus to further comprise a receiving two-transducer probe which receives the SH wave and the SV wave reflected by the defect in the test object and respectively converts to a first electric signal based on the SH wave and a second electric signal based on the SV wave.

Preferably, the ultrasonic diagnostic apparatus further comprises a noise processing part for performing the noise processing on the first electric signal and the second electric signal, a cross correlation processing part for generating a first electric compression signal by taking the cross correlation between the first electric signal after the noise processing and a first reference wave and generating a second electric compression signal by taking the cross correlation between the second electric signal after the noise processing and a second reference wave, and a display part for simultaneously displaying the first electric compression signal and the second electric compression signal.

Preferably, the noise processing part comprises an averaging circuit for respectively averaging the first electric signal and the second electric signal.

In addition, the present invention provides an ultrasonic diagnostic apparatus for detecting a defect in a concrete structure comprising: a signal generating part for generating a chirp wave; a compression processing part for performing a compression process on the chirp wave and outputting a chirp compression signal; and a P wave transducer for generating a P wave based on the chirp compression signal and propagating the P wave in the concrete structure.

Moreover, the present invention also provides the P wave transducer such that the P wave transducer receives the P wave reflected by the defect in the concrete structure and converts the P wave to an electric signal.

Moreover, the present invention also provides the ultrasonic diagnostic apparatus to further comprise a receiving P wave transducer which receives the P wave reflected by the defect in the concrete structure and converts the P wave to an electric signal.

Preferably, the ultrasonic diagnostic apparatus further comprises a noise processing part for performing the noise processing on the electric signal, a cross correlation processing part for generating a electric compression signal by taking the cross correlation between the electric signal after the noise processing and a reference wave, and a display part for displaying the electric compression signal.

Preferably, the noise processing part comprises an averaging circuit for averaging the electric signal.

### BRIEF DESCRIPTION OF THE DRAWINGS

FIG. 1 is a block diagram illustrating an embodiment of the ultrasonic diagnostic apparatus (sending side) according to the present invention.

FIG. 2 is an explanatory diagram illustrating a chirp wave.

FIG. 3 is a diagram illustrating a waveform of a chirp wave with a humming window.

FIG. 4 is a diagram illustrating a waveform of a chirp compression signal.

FIG. 5A is a diagram illustrating waveforms of a chirp wave before and after a compression process.

FIG. 5B is a diagram illustrating waveforms of a chirp wave with a humming window before and after a compression process.

FIG. 6 is a block diagram illustrating an embodiment of the ultrasonic diagnostic apparatus (receiving side) according to the present invention.

FIG. 7 is a diagram illustrating waveforms of a sine wave after a synchronizing addition.

FIG. 8A is a conceptual diagram illustrating the conventional processing of the echo signal.

FIG. 8B is a conceptual diagram illustrating the compression processing of the echo signal according to the present invention.

FIG. 9 is a perspective view of a two-transducer probe according to the present invention.

FIG. 10 is a conceptual diagram illustrating the relationship between a propagation velocity of an ultrasonic wave and an incidence angle, a refraction angle and a reflection angle of the ultrasonic wave.

FIG. 11 is a diagram illustrating a characteristic of a probe according to the present invention.

FIG. 12 is a diagram illustrating measurements of the impedance of the probe according to the present invention.

FIG. 13 is a diagram illustrating measurements of the resonance characteristic and the anti-resonance characteristic of the probe according to the present invention.

FIG. 14 is a diagram illustrating the comparison of the deterioration of a wedge of the probe according to the present invention.

FIG. 15 is a diagram illustrating the comparison of the sensitivity of a transducer of the probe according to the present invention.

FIG. 16 is a diagram illustrating an embodiment of the result of measurements of defects in a test object by the ultrasonic diagnostic apparatus according to the present invention.

FIG. 17A is a diagram illustrating a waveform of an echo signal processed by a conventional method.

FIG. 17B is a diagram illustrating a waveform of an echo signal processed by the method according to the present invention.

FIG. 18 is a diagram illustrating waveforms of echo signals using a burst wave and a pulse compression wave and the comparison of the S/N ratio of each echo signal.

FIG. 19 is a diagram illustrating waveforms of a sine wave before and after a compression process.

FIG. 20 is a view showing a frame format of a movable probe mounted on the test object.

FIG. 21 is a view showing a frame format of a SH wave propagating in a steel sheet adjacent to the concrete.

FIG. 22 is a view showing a frame format of an ultrasonic wave from a two-transducer probe mounted just above the defect.

FIG. 23 is a block diagram illustrating a conventional ultrasonic diagnostic apparatus.

FIG. 24 is a conceptual diagram illustrating a propagation of an ultrasonic wave and an echo signal for the conventional ultrasonic diagnostic apparatus.

FIG. 25 is a conceptual diagram illustrating an indirect reflection wave that does not alter the mode and an indirect reflection wave that alters the mode for the conventional ultrasonic diagnostic apparatus.

FIG. 26 is a diagram illustrating an ultrasonic wave propagating in a test object for the conventional ultrasonic diagnostic apparatus.

### DESCRIPTION OF THE PREFERRED EMBODIMENTS

Hereinafter, a preferred embodiment of the present invention will be described with reference to the drawings.

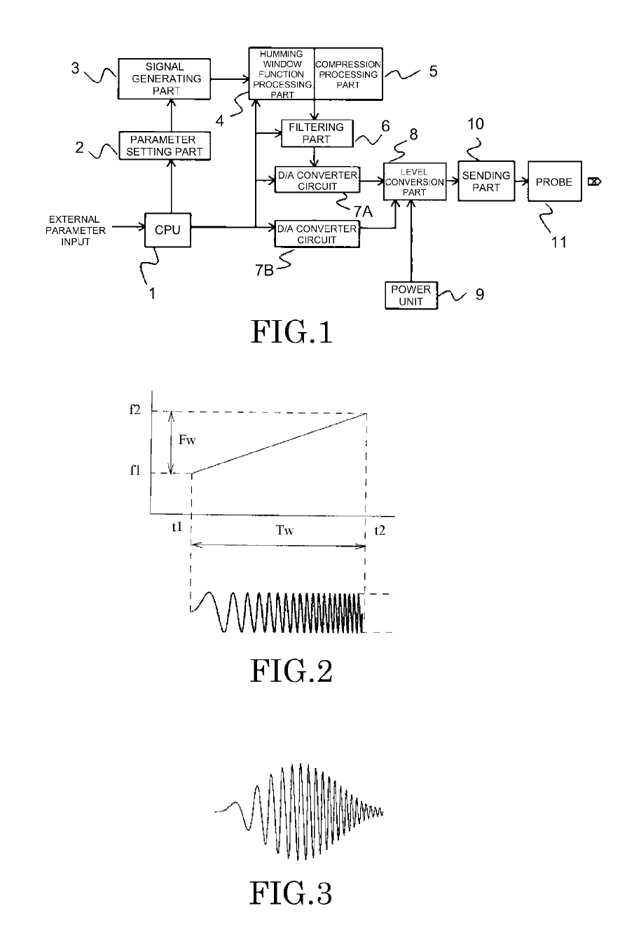

The sending side of the ultrasonic diagnostic apparatus according to the present invention is provided with a CPU 1, a parameter setting part 2, a digital wave generator (a signal generating part) 3, a humming window function processing part 4, a self correlation function processing part (a compression processing part) 5, a filtering part 6, a D/A converter circuit 7A, 7B, a level conversion part 8, a power unit 9, a sending part 10, and a probe 11 as shown in FIG. 1.

The digital wave generator 3 is controlled under the CPU 1, and emits the chirp wave which is configured at the parameter setting part 2 based on the input parameters from the external source. A chirp wave is a wave linearly altering a frequency from f1 to f2 between t1 and t2 as shown in FIG. 2. The chirp wave is weighted at the humming window function processing part 4 before the compression process at the self correlation function processing part 5. A weighted chirp wave with a humming window is expressed in the following equation (see FIG. 3).

S(t)=sin [2π{(Fc−Bw/2)t+(Bw/2Tw)t²}]·H(t) (1)

Bw: Chirp signal sweeping frequency band (f2-f1)

Tw: Chirp signal emission time length (t2-t1)

H(t): Humming window function

The humming window function H(t) is used for side-robe processing of the chirp wave after the compression process and is expressed in the following equation.

$$\begin{matrix}H ( t ) = \begin{matrix}0.54 - 0.46 cos \{ 2 π t / ( Tw ) ) \} & ( 0 ≦ t < Tw )\end{matrix} \\ = \begin{matrix}0 & ( t < 0 , t ≧ Tw )\end{matrix}\end{matrix} \qquad ( 2 )$$

Additionally, this chirp wave with a humming window is compressed by the self correlation function. The self correlation function Rₓₓ(τ) is an index as to the relation between a zone x(t1) of one unspecified signal x(t) and another zone x(t2) of one unspecified signal x(t) and, it is expressed in the following equation.

$${R}_{xx} ( τ ) = {lim}_{t \to ∞} \frac{1}{T} {\int }_{0}^{T} x ( t ) \cdot x ( t + τ ) d t τ \text{:} Gap of time ( delay ) \qquad ( 3 )$$

In terms of discrete quantity, the self correlation function Rₓₓ(j) against x(i) {i={0, 1, 2, 3 . . . N−1} can be described as

$${R}_{xx} ( j ) = \frac{1}{N} {\sum }_{i = 0}^{N - 1} x ( i ) \cdot x ( i + j ) \\ ( j = 0 , 1 , 2 , … , N - 1 ) \qquad ( 4 )$$

wherein, j indicates the gap between x(i) and x(i+j) with the number of samples. If the sampling interval is given Δt, j*Δt shows the gap of the time. However, the number of the data is finite, thus x(N), x(N+1), . . . cannot exist. Averaging to the number of the data points (in other words, to average via N-j, not via N due to loss of j), the self correlation function Rₓₓ(j) can be described as follows,

$${R}_{xx} ( j ) = \frac{1}{N - j} {\sum }_{i = 0}^{N - 1 - j} x ( i ) \cdot x ( i + j ) \\ ( j = 0 , 1 , 2 , … , N - 1 ) \qquad ( 5 )$$

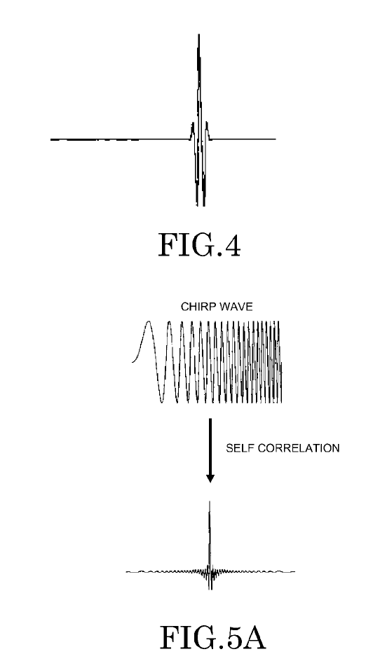

In the ultrasonic diagnostic apparatus according to the present invention, the chirp wave with a humming window is processed by the above self correlation function in order to obtain the chirp compression signal (see FIG. 4).

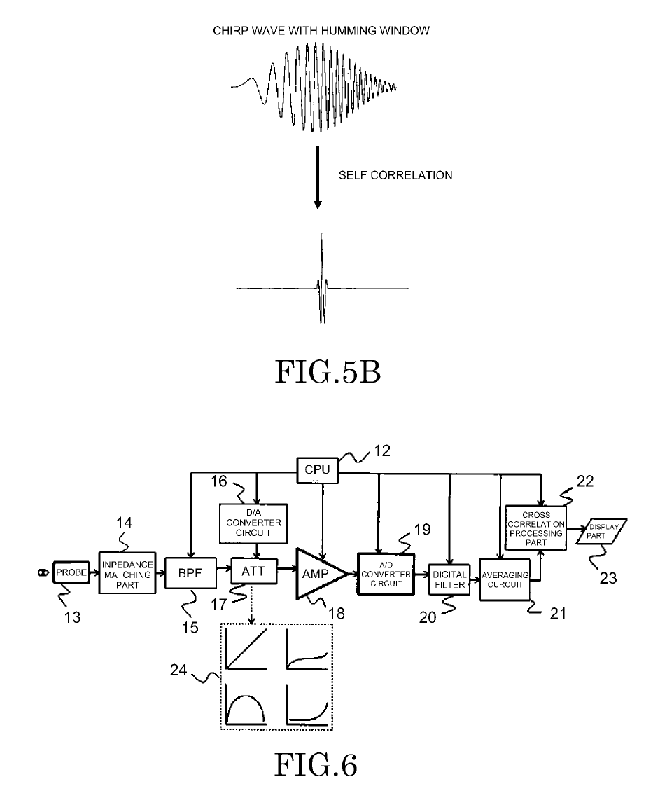

A chirp compression signal generated by compressing the chirp wave which is not weighted by the humming window function has an extension of the compression signal's side-robe as shown in FIG. 5A. The extension of the compression wave's side-robe can be the source of noise. In contrast, the chirp compression signal generated by compressing the chirp wave weighted by the humming window function reduces the extension of the compression signal's side-robe as shown in FIG. 5B. Alternatively the extension of the compression signal's side-robe can be deleted via software operations.

Additionally, in the filtering part 6, the FIR filtering process is performed on the chirp compression signal as a digital data for a waveform shaping. In this way, the chirp compression signal with less noise interference is obtained. The waveform-shaped chirp compression signal is converted to the analog signal in the D/A converter circuit 7A. In this case, the chirp compression signal is normalized.

The voltage of the power unit 9 is adjusted based on the signal of the CPU 1. The voltage level of the chirp compression signal converted to the analog signal is adjusted to suit the test object. In addition, the signal of CPU 1 is converted to the analog signal in the D/A converter circuit 7B and is sent to the level conversion part 8. The level conversion part 8 comprises an operational amplifier. For adjusting the voltage level of the signal except for the chirp compression signal, the level conversion part 8 may further comprise a FET.

In the level conversion part 8, the chirp compression signal varying from 0 to 10V is adjusted in a linear manner within the range from 0 to 1000V. Therefore, the chirp compression signal which is insusceptible to the sample size or shape can be obtained. The resultant chirp compression signal is sent to the probe 11 via the sending part 10.

The probe 11 generates an ultrasonic wave based on the chirp compression signal and propagates the ultrasonic wave in the test object. Here, it is preferable to use a 90-degree SH bevel probe as the probe 11. This is because the 90-degree SH bevel probe can propagate a SH wave (Shear Horizontal wave) in the test object such as steel sheet, and detect defects over a wide range.

The transducers of the probe have their own respective resonance frequency. Therefore, the wide-band signals do not retain sufficient energy if they are far from the transducer or the frequency of the signal differs in the resonance frequency.

The receiving side of the ultrasonic diagnostic apparatus according to the present invention is provided with a CPU 12, a probe 13, an impedance-matching part 14, a band path filter (BPF) 15, a D/A converter circuit 16, a programmable attenuator (ATT) 17, an amplifier (AMP) 18, a A/D converter circuit 19, a digital filter 20, an averaging (synchronizing addition) circuit 21, a cross correlation processing part 22, and a display part 23 as shown in FIG. 6. Here, it is preferable to use the CPU 1 as the CPU 12.

The probe 13 receives the reflecting SH wave (echo) from the test object, and it converts the echo into the electric signal (the echo signal). The 90-degree SH bevel probe of the sending side (probe 11) can be used as the probe 13. Also, a receiving probe such as the 90-degree SH bevel probe different from the probe 11 can be used as the probe 13.

The echo signal is processed for the impedance-matching at 50Ω in the impedance-matching part 14. The echo signal after the impedance-matching is processed for a noise rejection through the band path filter 15. The band path filter 15 is set at the frequency range at the time of compressing the chirp waves, for example, the frequency range by inputting parameters from the external source to the CPU 1. The band path filter 15 reduces the noise of the other frequencies than those that are pre-designated. The band path filter 15 can be replaced with the high-path filter (HPF) or low-path filter (LPF).

Next, by using the programmable attenuator 17, the voltage level of the echo signal is adjusted in accordance with the sampling rate time Δt of the D/A converter circuit 16, according to the CPU 12 command given. In addition, the signal from the CPU 12 is the digital signal within the range from 0 to 5V, so the signal is sent to the programmable attenuator 17 after converting to the analog signal in the D/A converter circuit 16. The programmable attenuator 17 can be set to any arbitrary time interval and voltage level (the characteristics are arbitrary, see 24 of FIG. 6). The programmable attenuator 17 does not have to be used in case the echo signal level is low. The programmable attenuator 17 improves the problem that is difficult to detect in the near-surface of the test object due to the S echo. The programmable attenuator 17 also prevents the saturation of the amplifier 18 in the next echelon where the amplifier gain is usually large.

The amplifier 18 is used for amplifying the reflecting echo signal from the defect in the test object (F echo) to a sufficient level. Here, it is preferable to use an amplifier with an excellent linearity as the amplifier 18.

The A/D converter circuit 19 has a resolution greater than 16-bit and a sampling rate higher than 200 MHz as a high-speed A/D converter, and it converts the echo signal into the accurate digital signal. Also, the A/D converter circuit 19 can be 12-bit models.

For instance, in case of the sampling of the echo signal of around 10 MHz by using the A/D converter with 100 MHz sampling rate, 10 sampling data points to one complete wave (1 cycle) of the received signal can be obtained. A 200 MHz sampling A/D converter can obtain 20 sampling data points, and its accuracy is double. Testing with the two-transducer probe respectively for the SV wave (Shear Vertical wave) and the SH wave, used in alternate shifts, decreases the sampling points to half. Therefore, for sampling in higher frequency or in alternate shifts with the two-transducer probe, the A/D converter with high sampling rate is recommended.

The digital filter 20 reduces the noise of the echo signal. The cutoff frequency of the digital filter 20 can be set to the echo signal depending on the CPU 12 command. A FIR type can be used as the digital filter 20. The digital filter 20 is not indispensable in case there is no difficulty in the testing.

Furthermore, the averaging (synchronizing addition) circuit 21 reduces the noise of the echo signal. The averaging circuit 21 is the integrated circuit that enables the addition averaging (the synchronizing addition) from 1 to approximately 1000 times. Repetition of the same testing and averaging of the sum reduces the noise and help detect the signals. The measured signal can be described as follows, basing the hardware structure on:

{χᵢⱼ} iεN,N={1, 2, . . . N} N: Number of the samples
jεM,M={1, 2, M} M: Number of the addition

The formula is given to all “i”.

$${P}_{i} = \frac{1}{M} {\sum }_{j ∈ M} {x}_{ij} \qquad ( 6 )$$

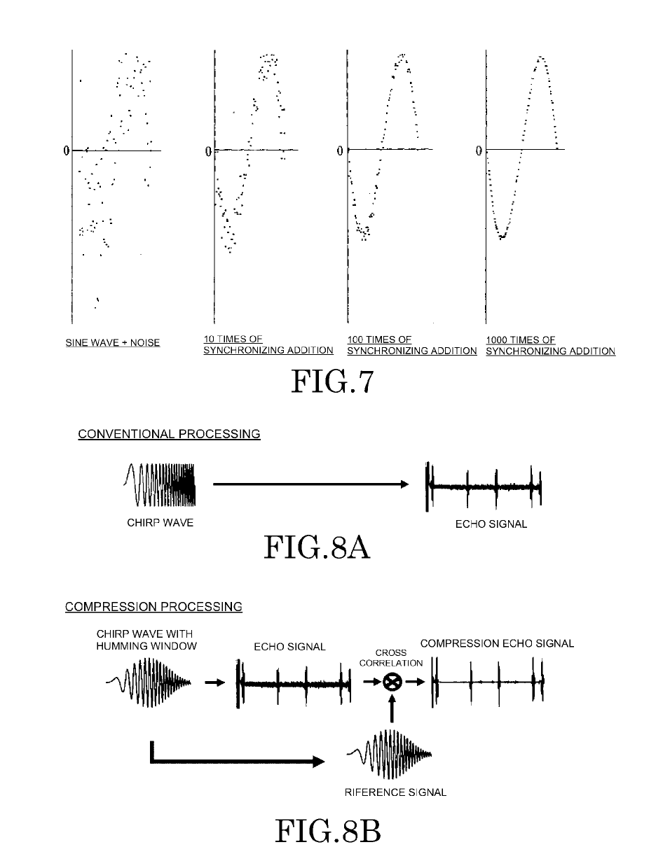

FIG. 7 is the result from the synchronizing addition up to 1000 times, using the sine wave. It shows that the sine wave is reproduced with the 1000-time synchronizing addition.

Actually, the first sampling receiving signal and the second sampling receiving signal are added in the identical time axis for later averaging. Therefore, in case of the 100-time synchronizing addition, the display part 23 displays the received data of one time after 100 sending pulses are emitted.

The echo signal after the synchronizing addition is compressed by correlating to the reference wave in the cross correlation processing part 22. The compression wave of the sending side can be used as the reference wave. However, other reference data can be facilitated as the reference wave. The cross correlation function is used in order to indicate the similarities between two signals, x(t) and y(t) or commonality identification of one signal to another in terms of the gap of time (delay). The definitional equation of the cross correlation function R_{xy}(j) for signal x(t) and y(t) dispersion data x(i){i=0, 1, 2, . . . N−1}, y(i){i=0, 1, 2, . . . N−1} can be described as follows,

$${R}_{xy} ( j ) = \frac{1}{N - j} {\sum }_{i = 0}^{N - 1 - j} x ( i ) \cdot y ( i + j ) \\ ( j = 0 , 1 , 2 , … , N - 1 ) \qquad ( 7 )$$

The compression echo signal after the cross correlation processing is displayed in the display part 23. Compared to the conventional process, the compression process according to the present invention is capable of the reduction of noise and the improvement of the S/N ratio as shown in FIG. 8A and FIG. 8B.

It is surely possible to generate arbitrary waves such as short-pulse, burst-signal, spike-wave or stepping function wave instead of using the chirp compression signals. Even with these signals, the ultrasonic diagnostic apparatus according to the present invention with a band path filter (BPF) 15, a digital filter 20 and the averaging (synchronizing addition) circuit 21 is capable of the use of the clear signal which has a lower noise level than the conventional methods.

The ultrasonic diagnostic apparatus according to the present invention can be also use for detecting a defect in a concrete structure. In case of detecting the defect in the concrete structure, it is preferable to use a P wave transducer instead of the 90-degree SH bevel probe. In such measurement, the chirp compression signal is applied similarly. The P wave (Longitudinal wave) is the wave that has same direction of oscillations along or parallel to the direction of travel, which is suitable for detecting the defect in the concrete structure.

In the flaw detecting for the concrete structure, the relatively low frequency is used, preferably the wide-band signal is used. Over time, the inside of the concrete structure becomes deteriorated and the concrete structure has an attenuation factor that prevents from transmitting the signal to the defect. Lower frequency can attain a deeper reach, but tends to miss a scant defect. The ultrasonic diagnostic apparatus according to the present invention can create the wide-band signal by using the chirp compression signal and increase the transmission capability.

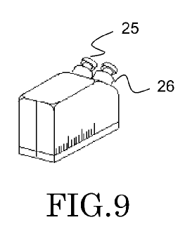

Next, referring to FIG. 9, the two-transducer bevel probe will be described. The two-transducer bevel probe is usually used in order to detect the small defect or measure the distance to the defect. The transducer for the SV wave 25 and the transducer for the SH wave 26 are respectively positioned in order to form the 90-degree two-transducer bevel probe.

In general, the SH wave has a tendency not to alter the mode conversion, but it has the difficulty of the incidence into the test object. On the other hand, the SV wave has the ease of the incidence into the test object, but it is susceptible to the effect of the test object surface and the mode conversion. In place of the 90-degree SH bevel probe, to deploy the 90-degree two-transducer bevel probe for emitting the SV wave and the SH wave in alternate shifts enables more accurate measurement of the defect in the test object.

The SV wave and the SH wave emitted as above are received in alternate shifts by the probe and they are displayed on the display part at the same time, which enables more accurate inspection on the location of the flaw. Additionally, by installing two units of the receiving side of the ultrasonic diagnostic apparatus according to the present invention, either of the emission signals enables the concurrent receipt of the SV wave and the SH wave. The influence of the mode conversion due to the indirect reflective wave or the delay echo can easily be identified for an easier judgment on the defect.

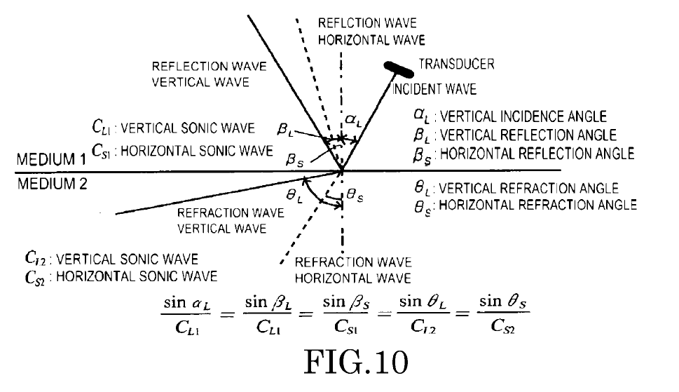

Next, actual examples for the 90-degree SH bevel probe will be described. When the SH wave transmits from the probe to the test object, it generates refractions. An incidence angle, a refraction angle and a reflection angle of the SH wave are generally shown as FIG. 10.

The 90-degree SH bevel probe prepared this time is provided with a transducer composed of a composite (1-3) material and a wedge composed of polyethylene. The ultrasonic horizontal velocity inside the polystyrene is 1135 m/s, while that of the steel sheet (test object) is 3245 m/s. The incidence angle in this case is,

g=(arc)sin [{(1135 m/s)/(3245 m/s)}×sin 90°]=20.5°

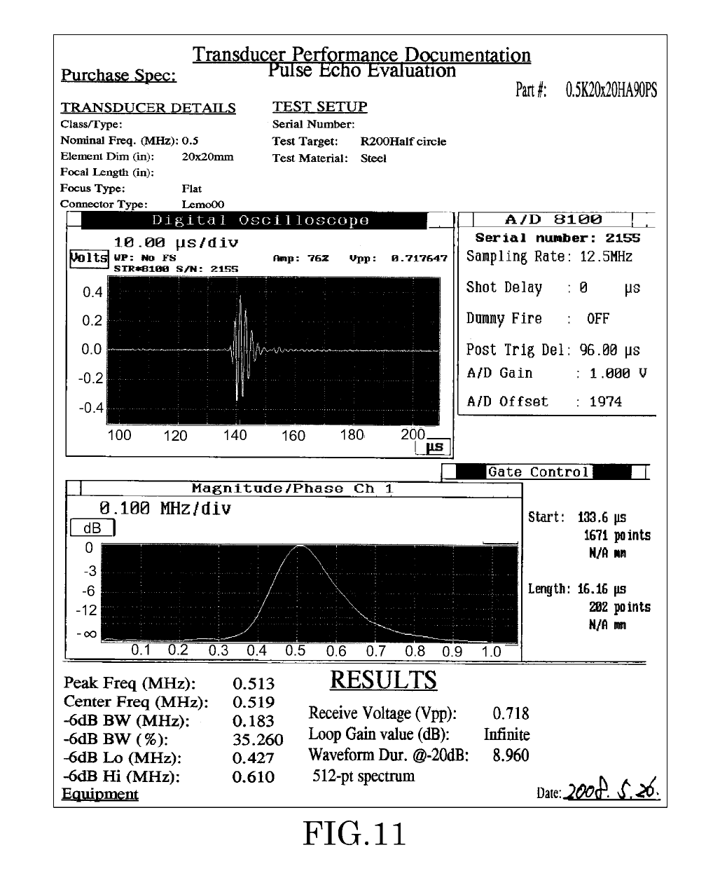

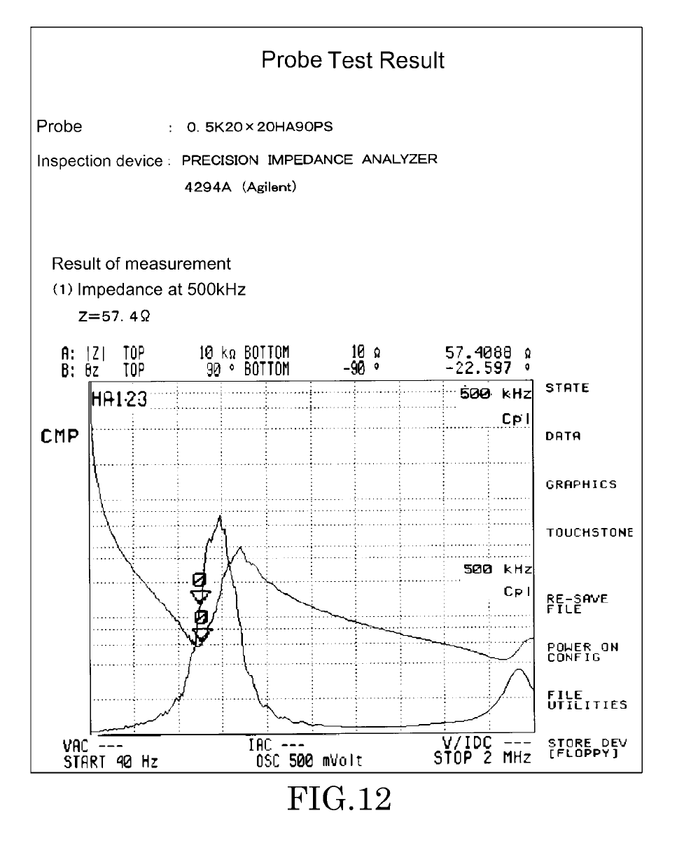

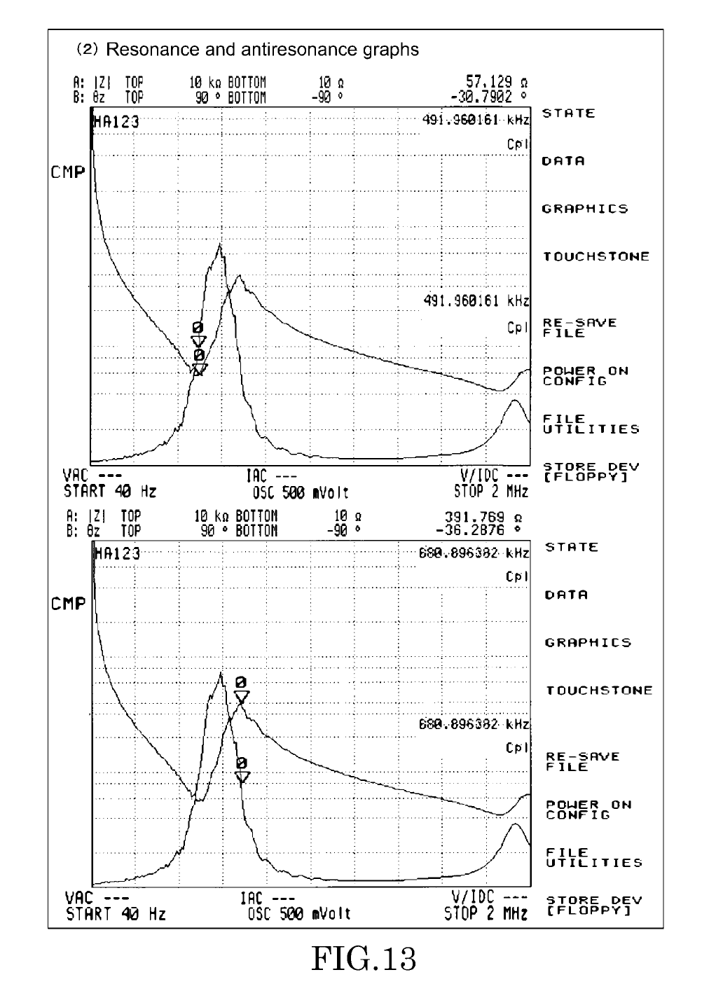

This is the optimum angle when the SH waves is emitted to the steel sheet in which the emitted wave linearly transmits itself horizontally, parallel to the steel sheet. The data obtained via the 90-degree SH bevel probe made with this optimum angle are shown in FIG. 11, FIG. 12 and FIG. 13. FIG. 11 is the diagram illustrating the characteristic of this probe. FIG. 12 is the diagram illustrating measurements of the impedance of this probe. FIG. 13 is the diagram illustrating measurements of the resonance characteristic and the anti-resonance characteristic of this probe. From the data, the desired 90-degree SH bevel probe is proven to be accurately manufactured.

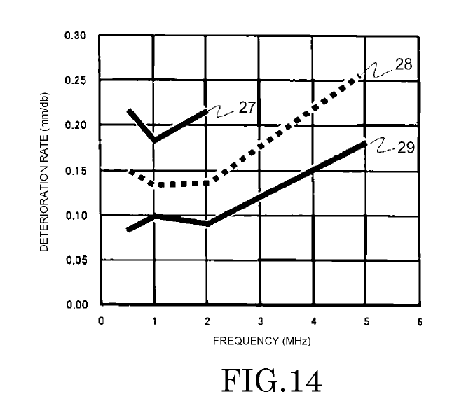

The wedge material of the 90-degree SH bevel probe and the deterioration data (the attenuation rate) at the polystyrene frequency are indicated as shown in FIG. 14. Comparing the attenuation rate of the wedge material, the acryl and the polystyrene, albeit slight differences per testing frequency, the attenuation rate of the polystyrene 29 at 1 MHz is 0.09 db/mm, to which the acryl 27 only registered 0.18 dB/mm, approximately half of the attenuation rate of the polystyrene 29. At 0.5 MHz, the attenuation rate of the polystyrene 29 is 0.08 db/mm, to which the acryl 27 only registered 0.22 dB/mm, approximately one third of the attenuation rate of the polystyrene 29. The attenuation rate of the polyetherimide 28 has approximately the value intermediate between the attenuation rate of the polystyrene 29 and the attenuation rate of the acryl 27.

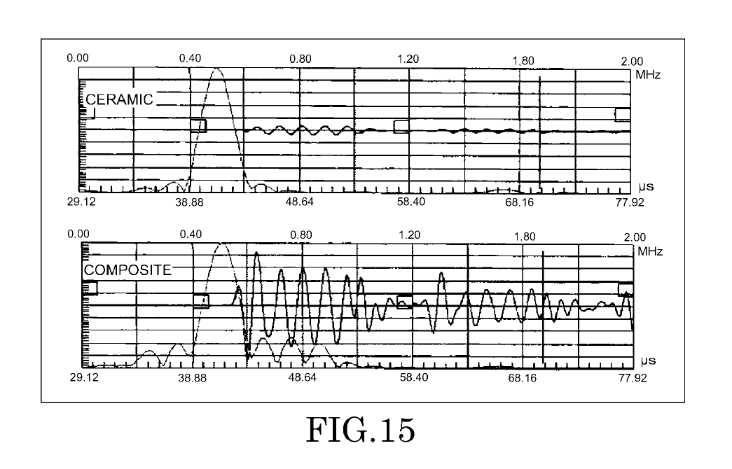

The comparison of the transducer composed of the ceramic with the composite (1-3) material is shown in FIG. 15. In FIG. 15, polyetherimide is used as a retardant and 5 burst waves with 0.5 MHz is used for this test. The transducer composed of the composite (1-3) material shows the sensitivity better than that of the ceramic by 14 dB to 20 dB or by 5 to 10 times more. Considering the area ratio, the transducer composed of the composite (1-3) material has a higher sensitivity by 7 dB to 14 dB than the transducer composed of the ceramic. While it is preferable to use the composite (1-3) material as the transducer material, it is not limited specifically thereto and another composite material may also be used as the transducer material.

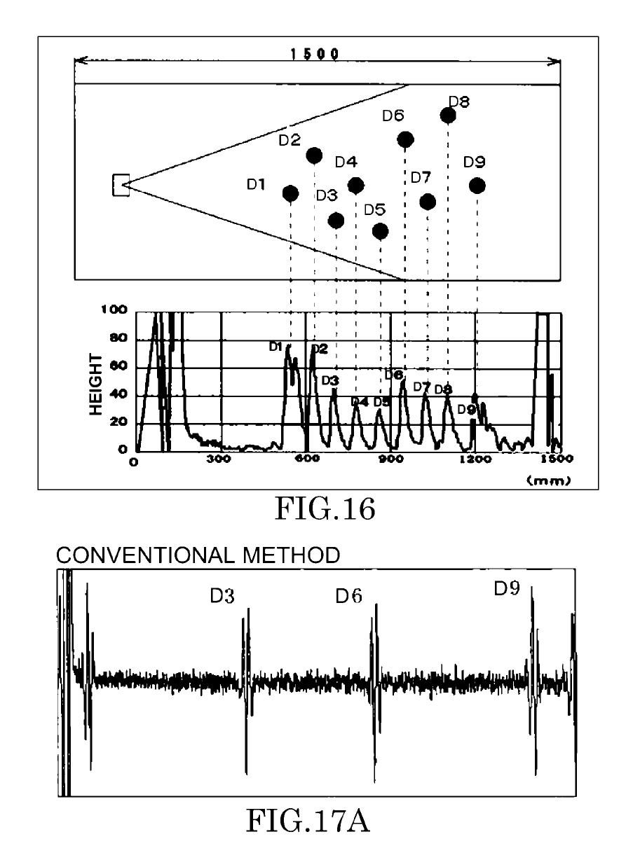

By employing the ultrasonic diagnostic apparatus according to the invention, 9 points of the defects have been made in the steel sheet and measured as shown in FIG. 16. The size of the defect is 3 mm in diameter and 5 mm in depth.

The D1 through D9 as shown in FIG. 16 are the defect information, D1 is the defect positioned at 500 mm from the edge, D2 is the defect positioned at 650 mm from the edge, D3 is the defect positioned at 700 mm from the edge, D4 is the defect positioned at 800 mm from the edge, D5 is the defect positioned at 850 mm from the edge, D6 is the defect positioned at 950 mm from the edge, D7 is the defect positioned at 1000 mm from the edge, D8 is the defect positioned at 1100 mm from the edge and D9 is the defect positioned at 1200 mm from the edge.

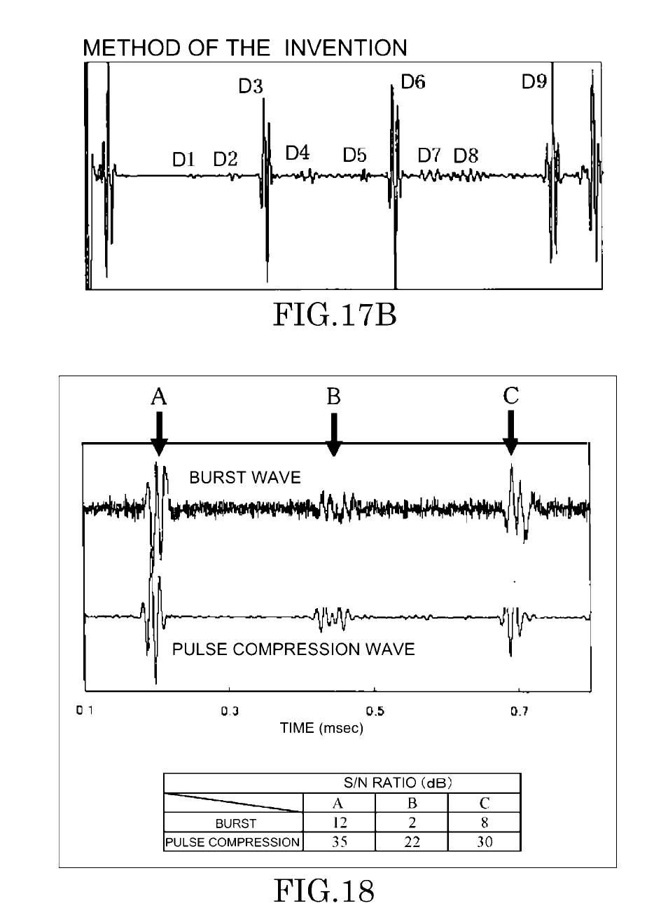

The result of the measurement by the conventional method using the burst wave with the actual noise is shown in FIG. 17A. The result of the measurement by the method according to the present invention using the compression wave is shown in FIG. 17B. The conventional method, compared to that of the compression waves, cannot identify any defect except for D3, D6 and D9. On the other hand, the method according to the present invention using the compression wave can identify all defects.

FIG. 18 indicates the S/N ratio of the echo signal by the 100 kHz burst wave and the echo signal by the pulse compression wave according to the present invention which has the center frequency around 100 kHz. The S/N ratio of the pulse compression wave shows the improvement by 20 dB compared to the S/N of the 100 kHz burst wave.

From the above points, the ultrasonic diagnostic apparatus according to the invention can receive the noise-reduced signal by using the chirp compression signal and it can detect the defects extensively by using the probe for generating the SH wave based on the chirp compression signal and for propagating the SH wave in the test object. Therefore, the ultrasonic diagnostic apparatus according to the invention is also ideal for detecting a defect in a bridge.

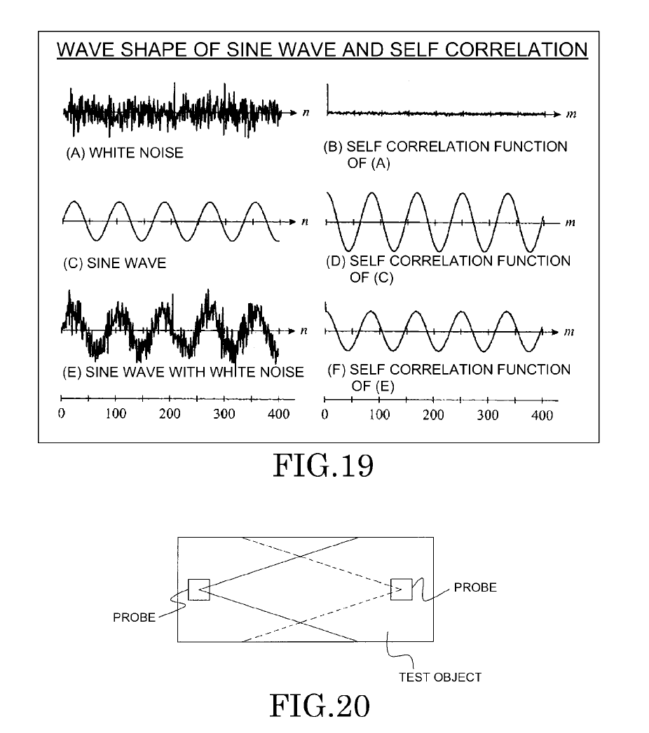

As shown in FIG. 19, with the software programs and with the self correlation function to the echo signal, further noise reduction can be attained and the clear signal can be obtained.

A phased Array sensor may be used as the ultrasonic diagnostic apparatus for detecting the defect in the steel sheet or the concrete structure, which can perform the directional control of the detection and detect the defect as the information of the plane.

The 90-degree SH bevel probe has a specific emission angle and thus the range may be limited. However, as shown in FIG. 20, the 90-degree SH bevel probe can be moved with ease.

Therefore, the multiple detections from different positions enable the detection to the entire test object.

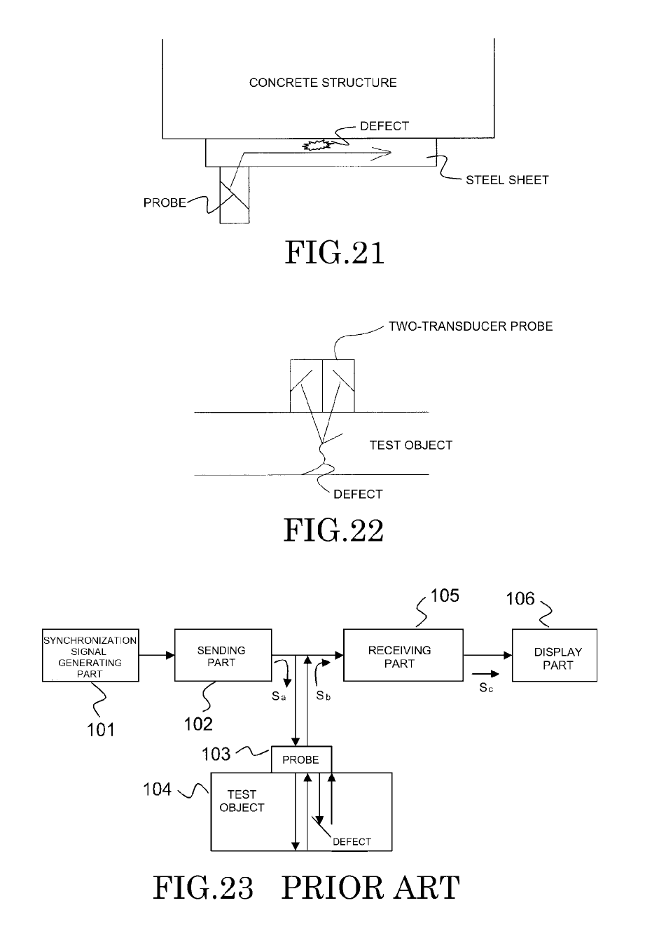

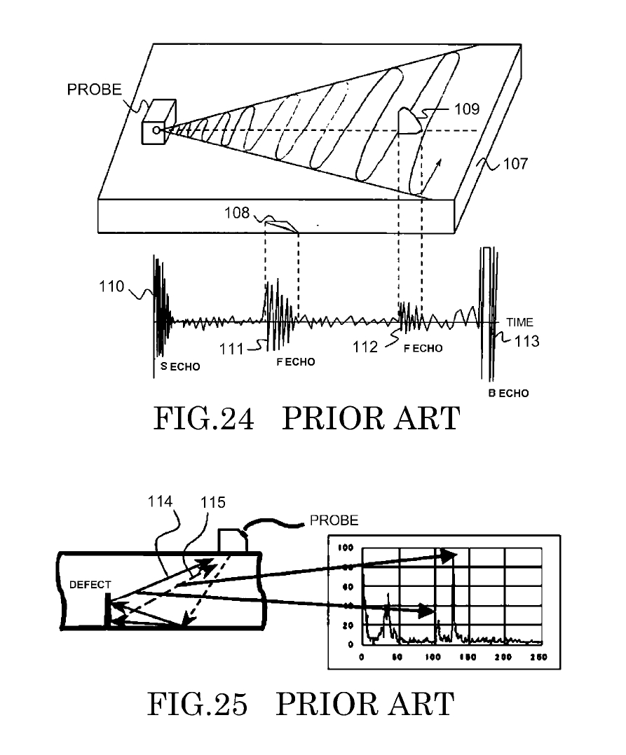

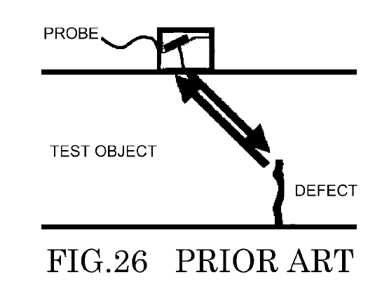

As shown in FIG. 21, the steel sheet adjacent to the concrete structure can also be inspected. The conventional SV wave is very prone to the concrete structure interference and the accurate echo signal cannot be received. However, the rust or cracks away from the measurement points can easily be detected by using the ultrasonic diagnostic apparatus according to the invention.

Also, in the two-transducer probe, outputting of the SH wave in order to receive the SV wave is available. The SH wave is hard to alter the mode and is resistant to influence by the other ambient effects. Even after the mode conversion due to the indirect reflection, the use of the two-transducer probe for receiving the SV waves can still localize the defect accurately. Additionally, as the method to obtain accurate defect information, the two-transducer probe can be brought and activated near the flaw for more detailed information as shown in FIG. 22.

The present invention is not limited to the description of the embodiments above, but may be altered by a skilled person within the scope of the claims. An embodiment based on a proper combination of technical means disclosed in different embodiments is encompassed in the technical scope of the present invention.

What is claimed is:

1. An ultrasonic diagnostic apparatus for detecting a defect in a test object comprising:
a signal generating part configured to generate a chirp wave;
a compression processing part configured to perform a compression process on the chirp wave and to output a chirp compression signal; and
a probe configured to generate a SH wave based on the chirp compression signal and configured to propagate the SH wave in the test object.

2. The ultrasonic diagnostic apparatus according to claim 1, wherein the probe receives the SH wave reflected by the defect in the test object and converts the SH wave to an electric signal.

3. The ultrasonic diagnostic apparatus according to claim 1, further comprising a receiving probe which receives the SH wave reflected by the defect in the test object and converts the SH wave to an electric signal.

4. The ultrasonic diagnostic apparatus according to claim 2, further comprising a noise processing part configured to perform the noise processing on the electric signal, a cross correlation processing part configured to generate an electric compression signal by taking the cross correlation between the electric signal after the noise processing and a reference wave, and a display part configured to display the electric compression signal.

5. The ultrasonic diagnostic apparatus according to claim 3, further comprising a noise processing part configured to perform the noise processing on the electric signal, a cross correlation processing part configured to generate an electric compression signal by taking the cross correlation between the electric signal after the noise processing and a reference wave, and a display part configured to display the electric compression signal.

6. The ultrasonic diagnostic apparatus according to claim 4, wherein the noise processing part comprises an averaging circuit configured to average the electric signal.

7. The ultrasonic diagnostic apparatus according to claim 5, wherein the noise processing part comprises an averaging circuit configured to average the electric signal.

8. The ultrasonic diagnostic apparatus according to claim 1, wherein the probe comprises a transducer composed of a composite material and a wedge composed of polyethylene.

9. An ultrasonic diagnostic apparatus for detecting a defect in a test object comprising:
a signal generating part configured to generate a chirp wave;
a compression processing part configured to perform a compression process on the chirp wave and configured to output a chirp compression signal; and
a two-transducer probe configured to generate a SH wave and a SV wave based on the chirp compression signal and configured to alternately propagate the SH wave and the SV wave in the test object.

10. The ultrasonic diagnostic apparatus according to claim 9, wherein the two-transducer probe receives the SH wave and the SV wave reflected by the defect in the test object and respectively converts to a first electric signal based on the SH wave and a second electric signal based on the SV wave.

11. The ultrasonic diagnostic apparatus according to claim 9, further comprising a receiving two-transducer probe which receives the SH wave and the SV wave reflected by the defect in the test object and respectively converts to a first electric signal based on the SH wave and a second electric signal based on the SV wave.

12. The ultrasonic diagnostic apparatus according to claim 10, further comprising a noise processing part configured to perform the noise processing on the first electric signal and the second electric signal, a cross correlation processing part configured to generate a first electric compression signal by taking the cross correlation between the first electric signal after the noise processing and a first reference wave and configured to generate a second electric compression signal by taking the cross correlation between the second electric signal after the noise processing and a second reference wave, and a display part configured to simultaneously display the first electric compression signal and the second electric compression signal.

13. The ultrasonic diagnostic apparatus according to claim 11, further comprising a noise processing part configured to perform the noise processing on the first electric signal and the second electric signal, a cross correlation processing part configured to generate a first electric compression signal by taking the cross correlation between the first electric signal after the noise processing and a first reference wave and configured to generate a second electric compression signal by taking the cross correlation between the second electric signal after the noise processing and a second reference wave, and a display part configured to simultaneously display the first electric compression signal and the second electric compression signal.

14. The ultrasonic diagnostic apparatus according to claim 12, wherein the noise processing part comprises an averaging circuit configured to respectively average the first electric signal and the second electric signal.

15. The ultrasonic diagnostic apparatus according to claim 13, wherein the noise processing part comprises an averaging circuit configured to respectively average the first electric signal and the second electric signal.

16. An ultrasonic diagnostic apparatus for detecting a defect in a concrete structure comprising:
a signal generating part configured to generate a chirp wave;
a compression processing part configured to perform a compression process on the chirp wave and configured to output a chirp compression signal; and
a P wave transducer configured to generate a P wave based on the chirp compression signal and configured to propagate the P wave in the concrete structure.

17. The ultrasonic diagnostic apparatus according to claim 16, wherein the P wave transducer receives the P wave reflected by the defect in the concrete structure and converts the P wave to an electric signal.

18. The ultrasonic diagnostic apparatus according to claim 16, further comprising a receiving P wave transducer which receives the P wave reflected by the defect in the concrete structure and converts the P wave to an electric signal.

19. The ultrasonic diagnostic apparatus according to claim 17, further comprising a noise processing part configured to perform the noise processing on the electric signal, a cross correlation processing part configured to generate an electric compression signal by taking the cross correlation between the electric signal after the noise processing and a reference wave, and a display part configured to display the electric compression signal.

20. The ultrasonic diagnostic apparatus according to claim 18, further comprising a noise processing part configured to perform the noise processing on the electric signal, a cross correlation processing part configured to generate an electric compression signal by taking the cross correlation between the electric signal after the noise processing and a reference wave, and a display part configured to display the electric compression signal.

21. The ultrasonic diagnostic apparatus according to claim 19, wherein the noise processing part comprises an averaging circuit configured to average the electric signal.

22. The ultrasonic diagnostic apparatus according to claim 20, wherein the noise processing part comprises an averaging circuit configured to average the electric signal.
